(19) United States
(12) Patent Application Publication
(10) Pub. No.: US 2013/0346325 A1
(43) Pub. Date: Dec. 26, 2013

(54) METHOD AND SYSTEM FOR ATTESTING VIA MOBILE DEVICES

(71) Applicant: M-QUBE, INC., Watertown, MA (US)

(72) Inventor: Alan SEGE, Los Angeles, CA (US)

(21) Appl. No.: 13/914,446

(22) Filed: Jun. 10, 2013

Related U.S. Application Data
(60) Provisional application No. 61/657,546, filed on Jun. 8, 2012.

(51) Int. Cl. G06Q 50/18; H04W 4/14

(52) U.S. Cl. CPC G06Q 50/18; H04W 4/14
USPC 705/311

(57) ABSTRACT

A method and system are provided for attesting users via mobile devices. The method includes receiving a request from the user. Further, the method includes sending a confirmation request message to a mobile number associated with the user, where the confirmation request message includes one or more statements for the user to certify. Still further, the method includes receiving a response message from the user, where the response message is received from the mobile number associated with the user. Further, the method includes matching the response message with an expected response for certification by the user. Finally, the method includes accepting the request of the user upon successful matching of the response message with the expected response.

### RELATED APPLICATIONS

The present application claims the benefit of priority from U.S. Provisional Application No. 61/657,546 entitled Method and System for Soliciting Political Contributions Via Mobile Device filed on Jun. 8, 2012, the entirety of which is incorporated by reference herein.

### BACKGROUND OF THE INVENTION

1. Field of the Invention

The present invention relates to attestation in general. More specifically, the present invention relates to a method and system for attesting via mobile devices.

2. Background

Organizations and individual citizens have a growing need to adhere to governance and compliance regulations, and in a lot of cases the organizations need to make sure that a service offered by them is provided only to eligible users. For example, the Federal Election Campaign Act (the “Act”) and Federal Election Commission (“Commission”) rules require that the treasurer of a political committee maintain the name and address of any person who makes a contribution in excess of $50 (along with the date and amount received) and prohibit foreign national contributions. Usually, in the offline world, organizations and government departments take signatures from users on the clauses where an attestation (or sworn statement) by a user is required. And in the online world, users often need to attest to their eligibility for a service (adulthood, non-employee status, etc.) before he or she is provided an access to certain services.

Increasingly, mobile devices are becoming ubiquitous among people, for work as well as for personal use such as photo sharing, video sharing, social networking applications and the like. As the usage of mobiles has proliferated, a lot of transactions, approvals and subscriptions have started taking place remotely on mobile. With their smaller screens and more limited user interaction, often organizations offering services that require user attestation have no convenient way to obtain correct attestations by users. Therefore, there is a need for a system to let a user certify via mobile devices.

Also, in the web world there is no sure way to determine if the information in a user attestation has actually been received and certified by the intended user. Typically, the users place information on websites without providing any type of independent verification of the information. Accordingly, all the information contained therein is self-asserted and cannot be verified. Therefore, there is a need for a system and a method to have a user certify, in a way that the information can be verified independently, if required. Mobile devices are addressable by specific unique phone numbers, IMEI, mobile-specific e-mail addresses and even network authentication by public mobile network operators. So involving such an identifiable mobile device in the process of obtaining an attestation by the device user also provides opportunities to solve this problem.

In the light of the foregoing discussion, there is a need for a method and system for obtaining remote attestation by certified users. Also, there is a need for a method and system that can provide attesting by users via mobile devices.

### SUMMARY

Accordingly, it is an object of the present invention to provide a method and system for providing a facility to users to certify attestations via mobile devices.

Accordingly, it is an object of the present invention to provide a method and system for providing a facility to organizations to obtain certified attestations from users remotely.

Accordingly, it is another object of the present invention to provide a method and system for verifying certain information certified by users. The above and other objects of the present invention are achieved by providing a method and system for attesting users via mobile devices. The method includes receiving a request from the user. Further, the method includes sending a confirmation request message to a mobile number associated with the user, where the confirmation request message includes one or more statements to which a user's attestation is desired. Still further, the method includes receiving a response message from the user, where the response message is received from the mobile handset identifier associated with the user. Further, the method includes matching the response message with an expected response for certification by the user. Finally, the method includes accepting the request of the user on successful matching of the response message with the expected response.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 shows an environment in which various aspects of the present invention can be practiced.

FIG. 2 shows an exemplary system diagram of various hardware components and other features, for use in accordance with an aspect of the present invention.

FIG. 3 shows a block diagram of various exemplary system components, in accordance with an aspect of the present invention.

FIG. 4 shows a block diagram of a system for attesting users via mobile devices, in accordance with an aspect of the present invention.

FIG. 5 shows a block diagram of a system for attesting users via mobile devices, in accordance with another aspect of the present invention.

FIG. 6 shows a flow chart of a method for attesting users via mobile devices, in accordance with an aspect of the present invention.

FIG. 7 shows a flow chart of a method for attesting users via mobile devices, in accordance with another aspect of the present invention.

FIG. 8 shows a flow chart of a sample use case of the method for attesting a user via a mobile device, in accordance with an aspect of the present invention.

FIG. 9 shows an example Graphical User Interface (GUI) screen, in accordance with an aspect of the present invention.

FIG. 10 shows a sample screenshot of a mobile device for attesting a user, in accordance with an aspect of the present invention.

FIGS. 11a-11d show screenshots of an implementation of a method for attesting a user, in accordance with aspects of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of aspects of the present invention.

### DETAILED DESCRIPTION

Before describing in detail the particular method and system for attesting users via mobile devices in accordance with an aspect of the present invention, it should be observed that the present invention resides primarily in combinations of method and system components related to communication device of the present invention.

Accordingly, the system components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

The terms “computing device” and “communication device” have been used interchangeably, and refer to computing device which has the capability of communicating or interacting with its users.

While the present invention has been described in connection with preferred aspects, it will be understood by those skilled in the art that variations and modifications of the preferred aspects described above may be made without departing from the scope of the invention. Other aspects will be apparent to those skilled in the art from a consideration of the specification or from a practice of the invention disclosed herein. It is intended that the specification and the described examples are considered exemplary only, with the true scope of the invention indicated by the following claims.

A method is provided for attesting a user via a mobile device, in accordance with an aspect of the present invention. The method includes receiving a request from the user. Further, the method includes sending a confirmation request message to a mobile number associated with the user, where the confirmation request message includes one or more statements to which the user is to attest. Still further, the method includes receiving a response message from the user, where the response message is received from the mobile number associated with the user. Further, the method includes matching the response message with an expected response for certification by the user. Finally, the method includes accepting the request of the user on successful matching of the response message with the expected response.

Aspects of the invention apply the invention's attestation scheme to mass individual payment transactions. In those exemplary aspects, a user makes an attestation as part of completing a financial transaction. Payment is processed for the merchant in concert with that scheme, in which a merchant can be paid by a payment processor, at least in part, promptly following the user's attestation, and payment can be completed once the processor in fact has received payment by the billing party, for example a public mobile network operator.

The present invention is exemplified herein by referencing attestation and contribution flows promoted by federal political committees during the 2012 presidential election campaign. But these are intended as examples only, and do not limit the claimed inventions to political contributions. In fact, certified attestation under the present invention is of interest to many government agencies, non-profit organizations, advocacy organizations, enterprises and mass user service providers of many sorts.

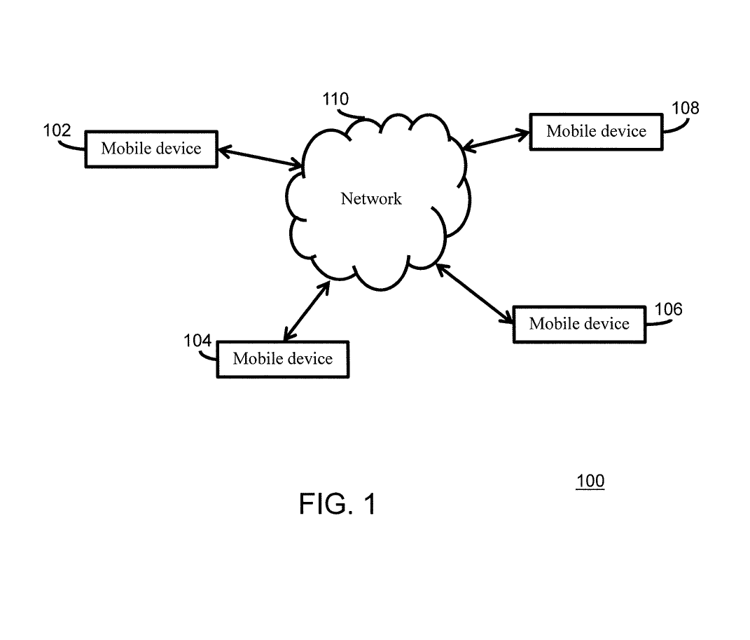

FIG. 1 shows an environment 100 in which various aspects of the present invention can be practised. The environment 100 includes a system connected to a plurality of mobile devices 102, 104, 106 & 108 via a network 110. In the present invention, a mobile device can be any device with a unique identity, capable of communicating through a network. Examples of the mobile devices include, but are not limited to, a mobile phone, a tablet PC, a netbook, an e-book reader, an embedded computing device and a PDA. The plurality of mobile devices 102, 104, 106 and 108 are connected to the system via the network. The network is one or more of a cellular network, a 2G network, a 3G network, a 4G network, and an internet network.

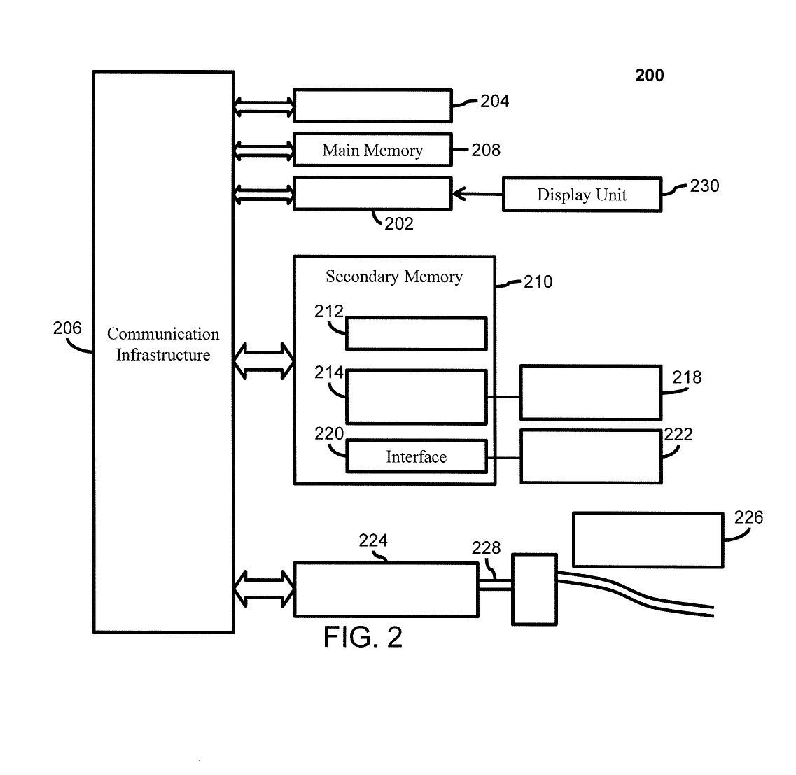

FIG. 2 shows an exemplary system diagram of various hardware components and other features, for use in accordance with an aspect of the present invention. The present invention may be implemented using hardware, software, or a combination thereof and may be implemented in one or more computer systems or other processing systems. In an aspect of the present invention, the invention is directed towards one or more computer systems capable of carrying out the functionality described herein. An example of such a computer system 200 is shown in FIG. 2.

Computer system 200 includes one or more processors, such as processor 204. The processor 204 is connected to a communication infrastructure 206 (e.g., a communications bus, cross-over bar, or network). Computer system 200 can include a display interface 202 that forwards graphics, text, and other data from the communication infrastructure 206 (or from a frame buffer not shown) for display on a display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative aspects of the present invention, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive, a hard disk installed in hard disk drive, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 210 to perform the features of the present invention. Accordingly, such computer programs represent controllers of the computer system 200.

In an aspect where the invention is implemented using software, the software may be stored in a computer program product and loaded into computer system 200 using the removable storage drive 214, the hard drive 212, or the communications interface 220. The control logic (software), when executed by the processor 204, causes the processor 204 to perform the functions of the invention as described herein. In another aspect of the present invention, the invention is implemented primarily in hardware using, for example, hardware components, such as application specific integrated circuits (ASICs). Implementation of the hardware state machine so as to perform the functions described herein will be apparent to persons skilled in the relevant art(s). In yet another aspect of the present invention, the invention is implemented using a combination of both hardware and software. Mobile devices such as mobile phones as well as general purpose personal computers are but examples of computer program products under the present invention. Where this specification refers to “website” that can include a World Wide Web page, a screen presented to a user in a mobile phone application or other end-user facing computer program or any type of graphic user interface presentation made to a user via a computing device.

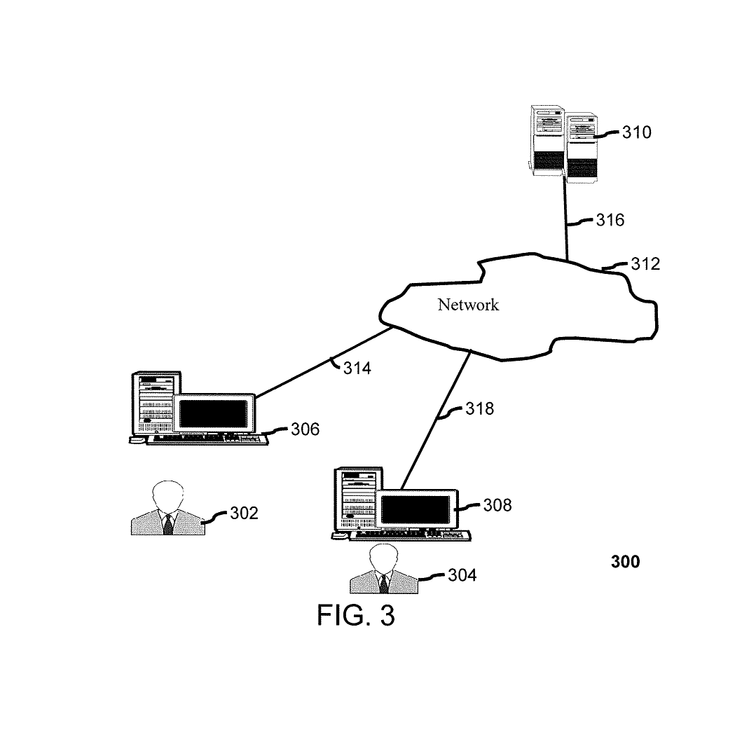

FIG. 3 is a block diagram of various exemplary system components, in accordance with an aspect of the present invention. The figure shows a communication system 300 usable in accordance with an aspect of the present invention. The communication system 300 includes one or more accessors 302 & 304 (also referred to interchangeably herein as one or more “users”) and one or more terminals 306 & 308. In an aspect of the present invention, data for use in accordance with the present invention is, for example, input and/or accessed by accessors 302 & 304 via terminals 306 & 308, such as personal computers (PCs), minicomputers, mainframe computers, microcomputers, telephonic devices, or wireless devices, such as personal digital assistants (“PDAs”), mobile phones or a hand-held wireless devices coupled to a server 310, such as a PC, minicomputer, mainframe computer, microcomputer, or other device having a processor and a repository for data and/or connection to a repository for data, via, for example, a network 312, such as the Internet or an intranet, and couplings 314, 316 & 318. The couplings 314, 316 & 318 include, for example, wired, wireless, or fiber optic links. In another aspect of the present invention, the method and system of the present invention operate in a stand-alone environment, such as on a single terminal. In a preferred aspect, the mobile device is addressable through an identifier that is unique to the mobile device such as a phone number, an e-mail address, an IMEI, a UID, an MUID, a smart phone operating system ID, a public mobile network's IP address or other unique identifier for the mobile device such as web page header enrichment or the like.

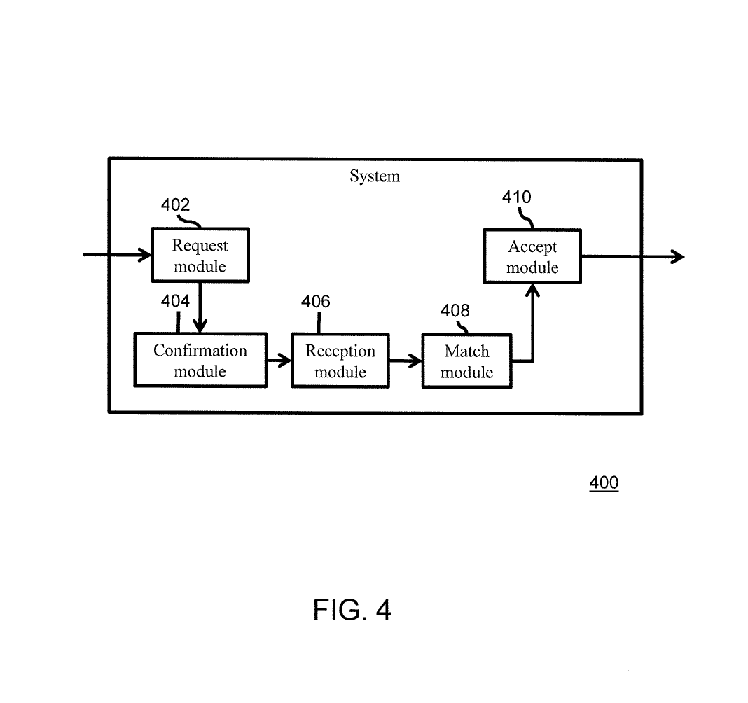

FIG. 4 shows a block diagram of a system 400 for attesting users via mobile devices, in accordance with an aspect of the present invention. The system 400 includes a request module 402, a confirmation module 404, a reception module 406, a match module 408, and an accept module 410. The request module 402 receives a request from a user. The request is received through one of a Short Messaging Service (SMS) message, a data message, a website, Unstructured Supplementary Service Data (USSD) service, a voice call and a multimedia call. For example, a user texts a pre-determined message to the system 400 via a phone number or in a preferred aspect via a common short code consisting of a five- or six-digit number. Another example is a user enters his or her mobile phone number a website provided by system 400 along with the request.

The confirmation module 404 sends a message to a mobile number associated with the user, where the message includes one or more statements to which the user is to attest. The confirmation request message is sent by one or more of Short Messaging Service (SMS), a push notification, Unstructured Supplementary Service Data (USSD) service, an instant messaging service based on mobile number, an e-mail address, or any other means of directing a statement for attestation to a mobile device. Examples of the one or more statements include, but are not limited to, age of the user, gender of the user, other eligibility criteria of the user, citizenship or residence of the user, confirmation of order, confirmation of payment instruction, confirmation of subscription, confirmation of donation request, and terms and conditions acceptance of an agreement. The confirmation request message can also include one of a PIN, a verification code and a keyword, which the user is supposed to send back in order to certify his attestation.

The reception module 406 then receives a response message from the user, where the response message is received from the mobile number associated with the user. The response message is received via one or more of a short code for SMS reception, a long number for SMS reception, a USSD command, an instant messaging account on an instant messaging service based on mobile number, a voice call on a pre-defined number, an email such as a certified e-mail, or other electronic transmission means, or even through physical signature delivered in person or by mail. In an aspect of the present invention, the response message can be received by any means which is tied to the mobile number of the user, the e-mail address associated with the user of the mobile device, or any other means that is known to be associated with the user making the attestation.

In a web page aspect of the present invention, in which a user has initiates the attestation process by entering his phone number or other mobile device address into a web page, the attestation statement is directed to the user's mobile device at that address. The statement sent to the mobile device by the confirmation module includes a PIN number, a CAPTCHA image, a graphic for identification or other information that is unique to that certification message. The reception module in that aspect receives the user's input of that PIN number or other unique identifier back into the web page.

Further, the match module 408 matches the response message with an expected response for certification by the user. Finally, the accept module 410 accepts the request of the user on successful matching of the response message with the expected response.

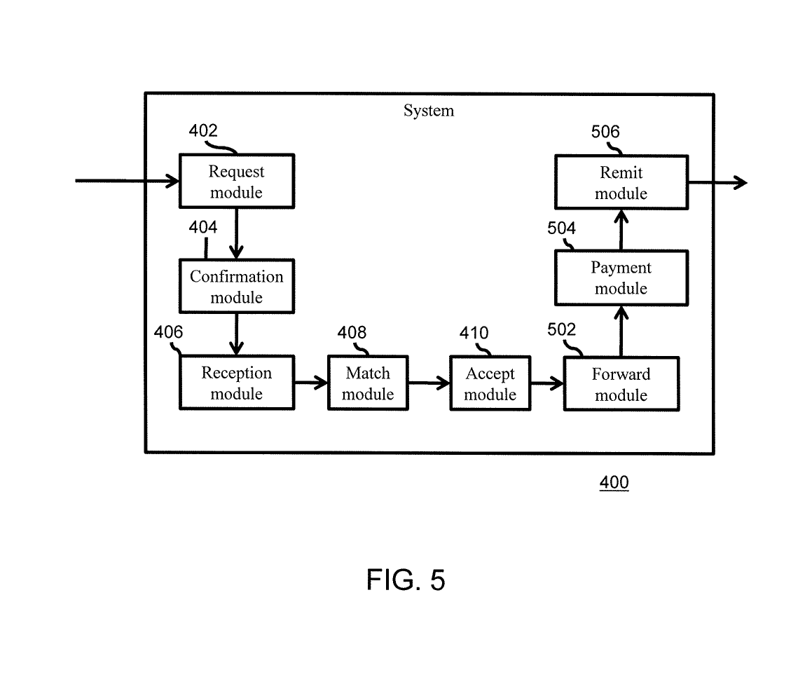

FIG. 5 shows a block diagram of the system 400 for attesting users via mobile devices, in accordance with another aspect of the present invention. The system 400 includes the request module 402, the confirmation module 404, the reception module 406, the match module 408, the accept module 410, a forward module 502, a payment module 504 and a remit module 506. The request module 402 receives a request from a user. The request is received through one of a Short Messaging Service (SMS) message, a data message, a website, Unstructured Supplementary Service Data (USSD) service, a voice call and a multimedia call. The confirmation module 404 sends a confirmation request message to a mobile number associated with the user, where the confirmation request message includes one or more statements for the user to certify. In an aspect of the present aspect, the request message is sent for attesting the user on behalf of a third party before approving a payment for the third party. The third party is one of a website, a subscription service, a political committee, and a government body.

The reception module 406 then receives a response message from the user, where the response message is received from the mobile number associated with the user. In the web page aspect of the present invention, the response message is received from a web page of the reception module 406 for receiving response from the user. Further, the match module 408 matches the response message with an expected response for certification by the user. The accept module 410 then accepts the request of the user on successful matching of the response message with the expected response. Further, the forward module 502 sends a status of the request to the third party. The associated account is one of a credit card account, a mobile carrier account, debit card account and a netbanking account. In an aspect of the present invention, the system 400 includes a receipt module, where the receipt module sends a receipt of acceptance of the request to the user. In an aspect of the present invention, the system 400 includes a verification module, where the verification module verifies information provided by the user with the carrier subscriber account details associated with the mobile number of the user.

The payment module 504 charges funds from an associated account of the user with a biller, where the funds are charged on behalf of the third party. In an aspect of the present invention, the payment module 504 includes a tracker module, where the tracker module tracks total funds received from the mobile number associated with the user. In an aspect of the present invention, the payment module 504 includes a reject module for rejecting the request of the user for charging the associated account when the total funds received from the mobile number associated with the user exceed a pre-set amount.

Finally, the remit module 506 transmits the charged funds to the third party. In an aspect of the present invention, the remit module includes an advance module, where the advance module transmits the charged funds in advance, before receiving the charged funds from the biller. In an aspect of the present invention, the advance module a fee module, where the fee module charges a financing fee for transmitting the funds in advance. In an aspect of the present invention, the advance module includes a partial payment module and remaining payment module. The partial payment module transmits the charged funds in advance partially, and the remaining payment module transmits remaining portion of the charged funds after receiving the charged funds from the biller.

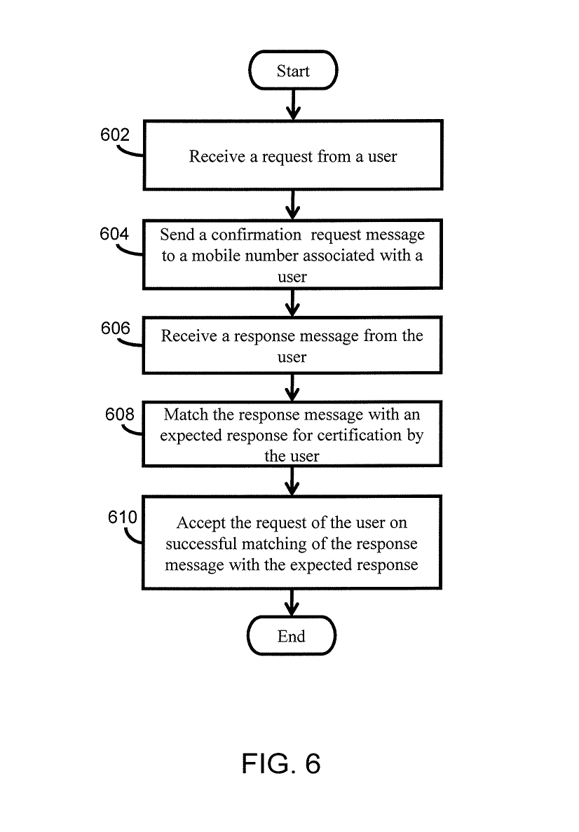

FIG. 6 shows a flow chart of a method for attesting users via mobile devices, in accordance with an aspect of the present invention. At step 602, the system 400 receives a request from the user. The request is received through one of a Short Messaging Service (SMS) message, a Multimedia Messaging Service (MMS), a data message, a website, Unstructured Supplementary Service Data (USSD) service, a voice call and a multimedia call. For example, a user texts a pre-determined message to the system 400 using a common short code consisting of a five- or six-digit number. Another example is a user enters his or her mobile phone number a website provided by system 400 along with the request.

At step 604, the system 400 sends a request message to a mobile number associated with the user, where the request message includes one or more statements for the user to certify. The confirmation request message is sent by one or more of Short Messaging Service (SMS), a Multimedia Messaging Service (MMS). a push notification, Unstructured Supplementary Service Data (USSD) service and an instant messaging service based on mobile number. Examples of the one or more statements include, but are not limited to, age of the user, gender of the user, other eligibility criteria of the user, citizenship or residence of the user, confirmation of order, confirmation of payment instruction, confirmation of subscription, confirmation of donation request, employment status of the user, organizational affiliation of the user, beliefs of the user, religion of the user and terms and conditions acceptance of an agreement. The confirmation request message can also include one of a PIN, a verification code, a CAPTCHA, a unique image, a puzzle and a keyword, which the user is supposed to send back for certification.

Further, at step 606, the system 400 receives a response message from the user. The response message is received via one or more of a short code for SMS reception, a long number for SMS reception, a USSD command, a web page, a website, an instant messaging account on an instant messaging service based on mobile number and a voice call on a pre-defined number. Further, at step 608, the system 400 matches the response message with an expected response for certification by the user. Finally, at step 610, the system 400 accepts the request of the user on successful matching of the response message with the expected response.

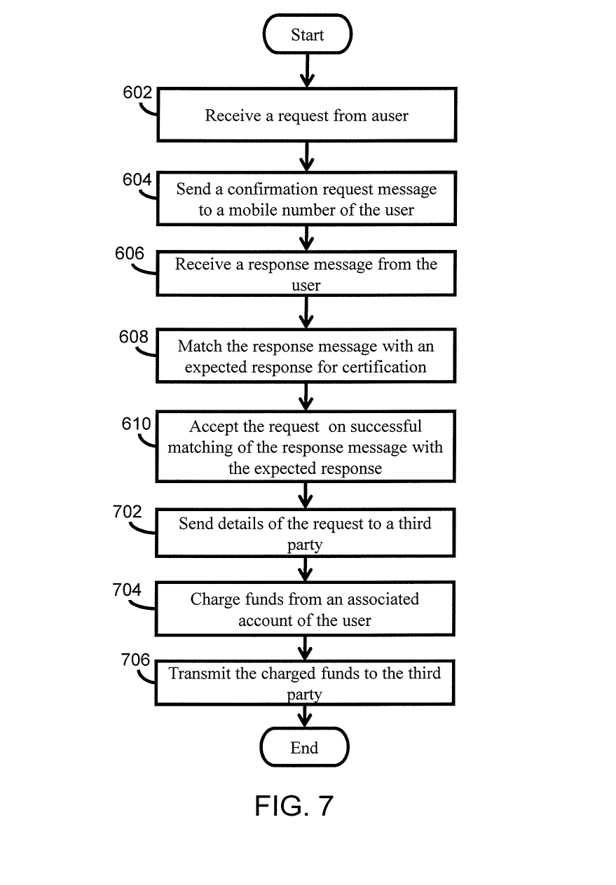

FIG. 7 shows a flow chart of a method for attesting users via mobile devices, in accordance with another aspect of the present invention. At step 602, the system 400 receives a request from the user. At step 604, the system 400 sends a request message to a mobile number associated with the user, where the request message includes one or more attestation statements for the user to certify. In an aspect, the request message is sent for attesting the user on behalf of a third party before approving a payment for the third party. The third party can be one of a website, a subscription service, a membership or advocacy organization, a professional or trade association, a charity or non-profit organization, a newspaper or media publication, a video game provider, a political committee, and a government body. Further, at step 606, the system 400 receives a response message from the user, where the response message is received from the mobile number associated with the user or by the user entering a unique identifier like a PIN or description of an image or characters of a CAPTCHA into a webpage. Further, at step 608, the system 400 matches the response message with an expected response for certification by the user. Finally, at step 610, the system 400 accepts the request of the user on successful matching of the response message with the expected response. At step 702, the system 400 sends details of the acceptance of the request to the third party. At step 704, the system 400 charges funds from an associated account of the user with a biller, the funds being charged on behalf of the third party. Examples of the associated account include, but are not limited to, a credit card account, a public mobile operator account, an internet service provider bill, a cable television or interactive television bill, a broadband provider account, a utility bill, a phone bill, a debit card account, a checking account, a payroll account and a netbanking account. In an aspect of the present invention, the system 400 tracks total funds received from the mobile number associated with the user. In an aspect of the present invention, the request of the user for charging the associated account is rejected, when the total funds received from the mobile number associated with the user exceed a pre-set amount.

Finally, at step 706, the system 400 transmits the charged funds to the third party. In an aspect of the present invention, the funds are transmitted to the third party in advance, i.e. before receiving the charged funds from the biller. The funds can be transmitted in advance partially or completely. In case the funds are transmitted partially, the remaining portion of the charged funds is transferred after receiving the charged funds from the biller. In an aspect, the system 400 charges a financing fee for transmitting the funds in advance.

In an aspect of the present invention, the system 400 sends a receipt of acceptance of the request to the user. The receipt can include a ‘thank you’ message for the user. In another aspect of the present invention, the system 400 is capable of verifying information provided by the user with the carrier subscriber account details associated with the mobile number of the user. This can help in identity verification of the user, if required.

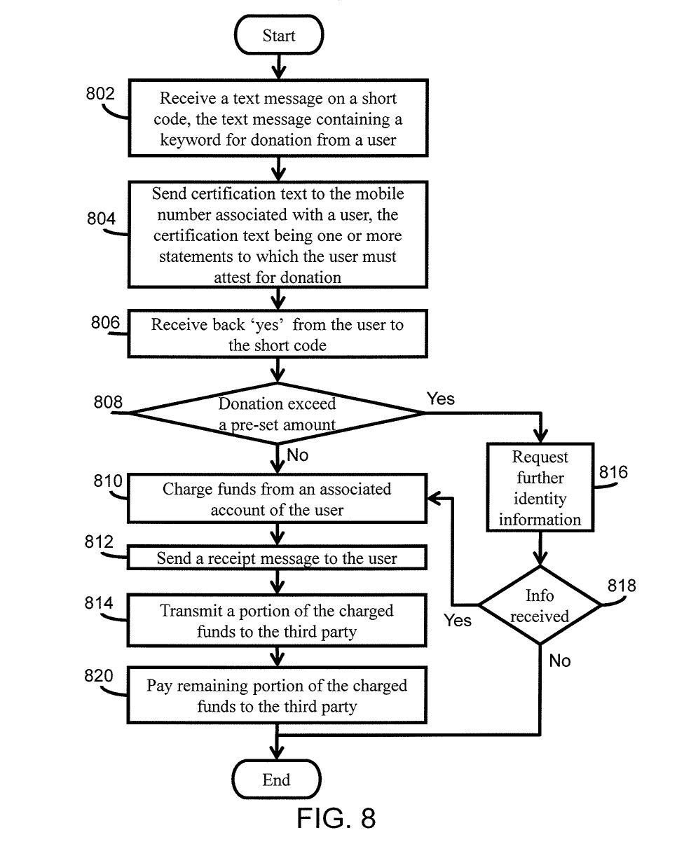

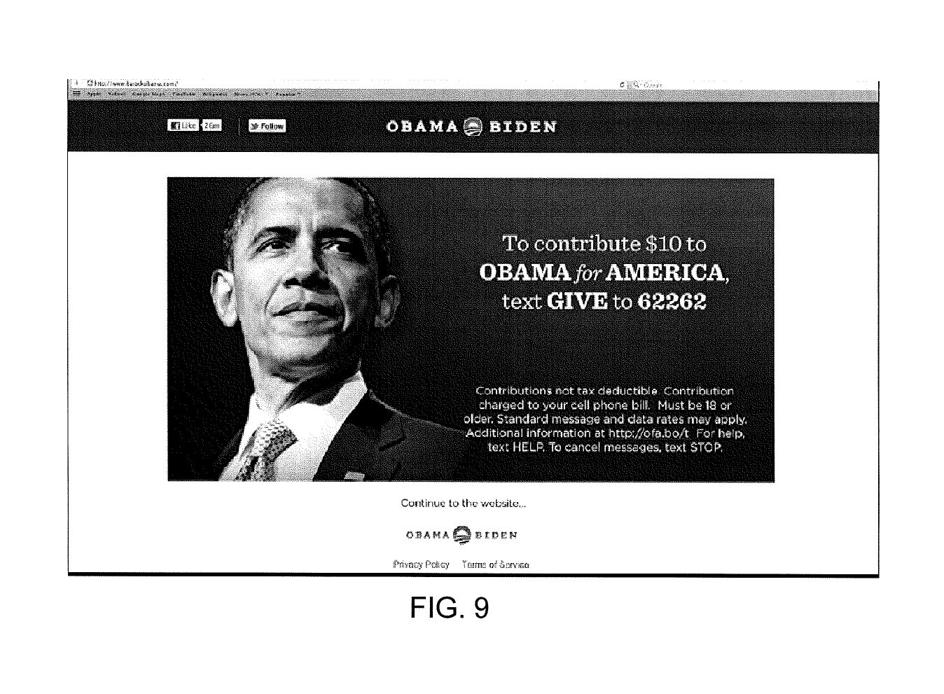

FIG. 8 shows a flow chart of a sample use case of the method for attesting a user via a mobile device, in accordance with an aspect of the present invention. The user sees an advertisement to participate in a service that requires attestation, which could be a website such as that shown in FIG. 9 or a television, radio, print, web or other advertisement prompting the user to “To donate, text ‘GIVE’ to short code XXXXX.”

At step 802, the system 400 receives a text message on a short code, the text message containing a keyword for donation from a user. In a web-opt-in aspect, the system receives a phone number or other mobile device identifier input by a user into a website or an app. The user texts a pre-determined message to a political committee using a common short code consisting of a five- or six-digit number. In another aspect of the present invention, the user enters his or her mobile phone number on a political committee's website in lieu of a credit card number. The Federal Election Campaign Act and also Federal Election regulations of U.S. require that foreign national contributions are prohibited to a political committee. In an aspect of the present invention, the system 400 only allows users that obtain service through U.S.-based providers to use a short code to complete the opt-in. Since common short codes are country-specific and only work on handsets subscribed to mobile network operators within a given country, only users that obtain service through U.S.-based wireless service providers will be able to use a short code to complete the process.

At step 804, the system 400 sends certification text to the mobile number associated with the user, the certification text being one or more statements to which the user must attest for donation.

For example, in the web opt-in aspect wherein a user has to input his mobile number into a website, the less-than-164 character SMS message could read, “Enter PIN to give $XX for Obama Contribution. PIN: XXXX Info: http://OFA.BO/t or Reply HELP for help. Msg&Data Rates May Apply.”

In the aspect wherein a user has texted a pre-defined keyword to a short code, the less-than-164 character SMS message could read, “Reply YES to give $10 to Obama, billed 2 phone. U certify u r 18+ & donating with own funds, not foreign national or Fed contractor. TERMS: http://ofa.bo/t”

The Act further requires that the donations are only received from the eligible users. The Act and Commission regulations prohibit corporations from making a contribution in connection with a federal election. 2 U.S.C. §441b(a) and 11 CFR 114.2(b)(1). The definition of contribution includes “any gift, subscription, loan, advance, or deposit of money or anything of value made by any person for the purpose of influencing any election for Federal office.” 2 U.S.C. §431(8)(A)(i) and 11 CFR 100.52(a). “Anything of value” includes all in-kind contributions, including the provision of goods or services without charge or at a charge that is less than the usual and normal charge. 11 CFR 100.52(d)(1). Thus the present invention requires a wireless user to confirm that they intend to engage in the transaction and to certify that they are eligible to make a contribution under the Act. At step 806, the system 400 receives back ‘yes’ from the user to the short code. In another aspect of the present invention, the system 400 receives a PIN number or other unique identifier sent to the user's handset and transcribed by the user back into the website.

In the aspect where the user has attested by texting “YES,” the less-than-164 character message could read, “$10 Obama Contribution billed to your phone. Give up to $50/mo. Info: http://OFA.BO/t Txt HELP for help, STOP to end.8005551234 Msg&DataRatesMayApply+6 alerts/mo”.

In the aspect where the user has attested by inputting a PIN into the website, the less-than-164 character message could read, “$XX Obama Contribution billed to your phone. Give up to $50/mth. Info? Visit http://OFA.BO/t Txt HELP for help, STOP to end. 855-856-2262 Msg&Data Rates May Apply”.

In another aspect of the present invention, once the user has completed this “opt-in” process, a charge is placed on a billing account of the user. In an aspect of the present invention, the billing account is an account of the user's wireless mobile phone number.

The Act and Commission regulations require that treasurer of a political committee maintain the name and address of any person who makes a contribution in excess of $50, along with the date and amount received. 2 U.S.C. §432(c)(1)-(3). Treasurers must also examine all contributions for evidence of illegality and ensure that those contributions, when aggregated with others received from the same contributor, do not exceed the Act's contribution limits. 11 CFR 103.3(b). In an aspect of the present invention, at step 808, the system 400 checks if the donations by the user (after adding the offered donation to the past donations) have exceeded a pre-set amount. In case the donations received from the user have not exceeded the pre-set amount (which is currently $50 in case of political contributions), the system 400 charges funds from a billing account associated with the user at step 810. In an aspect of the present invention, the system 400 maintains a running tally of the pre-set cap placed on contributions made via text message each month from the same mobile number and provides political committees with real-time access to the maintained tally of contributions.

In another aspect of the present invention, the donations exceed the pre-set amount. The system 400 then requests further identity information from the user at step 816. Further, at step 818, if the system 400 receives the required identity information from the user, the donation request is accepted from the user, and the system 400 charges funds from a billing account associated with the user at step 810.

In an aspect of the present invention, at step 812, the system 400 sends a receipt of the payment to the user. The receipt can also include a ‘thank you’ note for the user.

Further, the Act sets time frames on when a person who receives a contribution on behalf of a political committee must forward that contribution to the committee's treasurer. 2 U.S.C. §432(b) and 11 CFR 102.8. At step 814, the system transmits a portion of the charged funds to the third party (political committee in this case) in advance (factored payments). The advance payments can be transmitted on one of a daily, weekly, bi-weekly and monthly basis, based on the successful opt-ins. In an aspect of the present invention, the system 400 charges a financing fee to the political committee for the factored payments. In an aspect of the present invention, the system 400 does not provide contributor (user) names and addresses to political committees, but provides the phone number associated with each contribution. In an aspect of the present invention, the system 400 provides the amount and date of the contribution, and confirms that the contributor (user) opted to have the contribution charged to their wireless bill and that the contributor affirmatively answered the questions indicating their eligibility to contribute.

The system 400 waits to receive payments from the biller. In the present aspect, the biller is the mobile carrier of the user. The system 400 recoups its funds once subscribers have paid their bill and the mobile carriers have transmitted those payments, net of any fees, to the system 400. Further, it can take 90 days or more to receive payments from the mobile carrier following the opt-ins. In an aspect of the present invention, the system 400 calculates and transmits a “conservative factor” to political committees and re-evaluates the potential risks of making the factored payments on a weekly basis. In an aspect of the present invention, the system 400 requires third parties to provide a security deposit to guard against overpayments. Additionally, the system 400 may require any overpayments to be reimbursed by the customer.

Finally, at step 820, the system 400 pays the un-advanced balance to the third party (political committee) after receiving full payment from the biller.

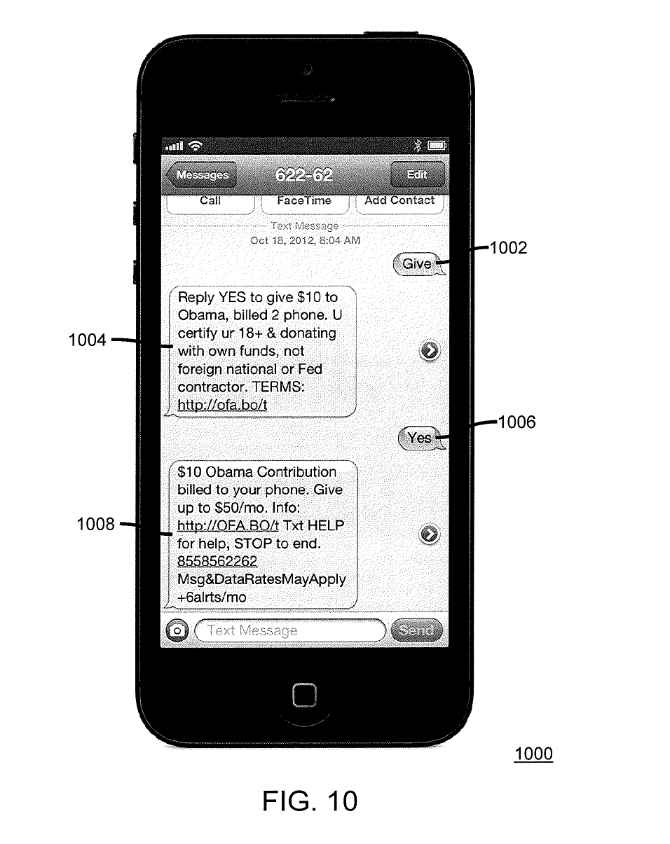

FIG. 10 shows a sample screenshot of a mobile device for attesting a user, in accordance with an aspect of the present invention. The user sends a request via a text message 1002 with a keyword “Give” to a short code number “622-62”. The short code number in the present aspect is associated to a political committee of Obama, where the short code is being used for sending donations to the political committee. The mobile device then receives a text message 1004, containing statements to be certified by the user, before a donation can be accepted from the user. The user can then certify the statements by replying with a text message containing “Yes”. The user replies with the text message 1006. The request is then accepted, and a donation of $10 is charged to the mobile carrier account of the user. The user then receives a text message 1008 containing details of the donation transaction.

In another aspect of the present invention, a wireless user enters his or her mobile phone number on a political committee's website in lieu of a credit card number. Before submitting the phone number, the user is required to certify his or her eligibility to make a contribution under the Act. After the user certifies the information, the system 400 transmits a text message to the user's mobile phone that includes a first personal identification number (PIN). The user then enters a second PIN on the political committee's website to confirm the transaction. Upon verification that the first and second PIN numbers are the same, and upon verification that the total billed amount does not exceed a pre-specified amount, the system 400 bills an account associated with the mobile telephone number for the pre-set or user-selected contribution amount.

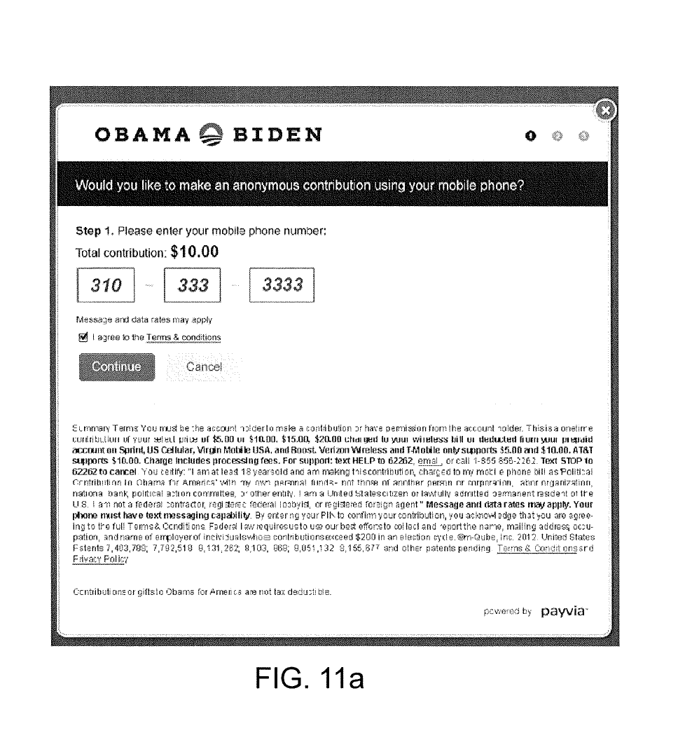

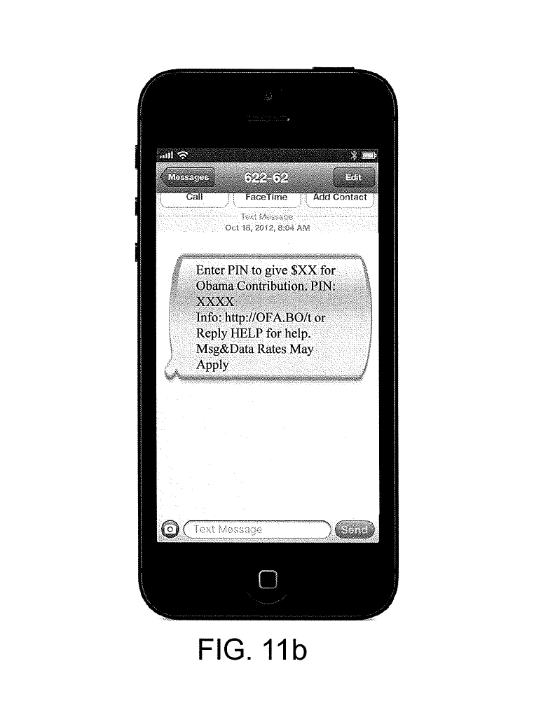

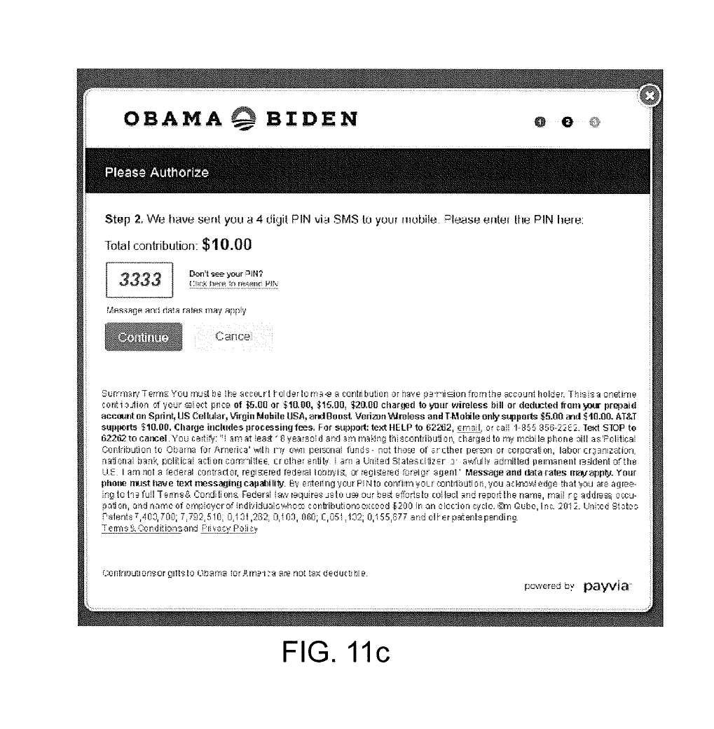

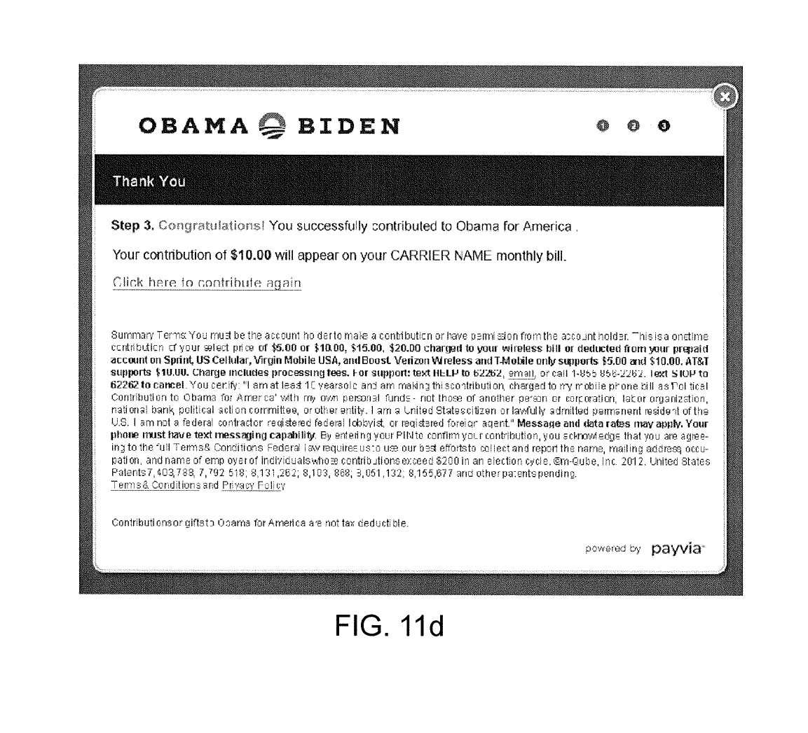

FIG. 11a-11d shows screenshots of an implementation of a method for attesting a user, in accordance with an aspect of the present invention. FIG. 11a shows that a user enters his or her mobile phone number on a political committee's website. Before submitting the phone number, the user is required to certify his or her eligibility to make a contribution under the Act. In the present example, the user enters the mobile phone number on the website of political committee of Obama. FIG. 11b shows that the user then receives a text message containing a first PIN to confirm the contribution and to attest to the terms. FIG. 11c shows that the user then enters a second PIN on the website of the political committee. Finally, FIG. 11d shows that on successful verification of the PIN, contribution from the user is accepted.

Thus, once a user has completed this “opt-in” process, a charge is placed on the account of the user's wireless mobile phone number. Since common short codes are country-specific, only users that obtain service through U.S.-based wireless service providers will be able to use a short code to complete the opt-in process. Additionally, the payments that system receives from the service providers and forwards to political committees are linked to a common short code that is unique to each committee. This ensures that political contributions are properly accounted for and that treasury funds are not transmitted to any political committee.

A description of an example aspect of the present invention may be found in the following Federal Election Commission (FEC) documents associated with FEC Advisory Opinion 2012-17 dated Jun. 11, 2012: (a) Request by Red Blue T LLC, ArmourMedia, Inc., and m-Qube, Inc., dated Apr. 5, 2012; (b) Supplemental Material from Red Blue T LLC, ArmourMedia, Inc., and m-Qube, Inc., dated May 16, 2012; (c) Supplemental Material from Red Blue T LLC, ArmourMedia, Inc., and m-Qube, Inc., dated Jun. 4, 2012; (d) Supplemental Material from Red Blue T LLC, ArmourMedia, Inc., and m-Qube, Inc., dated Jun. 6, 2012; and (e) Supplemental Material from Red Blue T LLC, ArmourMedia, Inc., and m-Qube, Inc., dated Jun. 7, 2012. Each of the preceding documents (a)-(e) may be found on the FEC website, and each is incorporated by reference herein.

Appendix 1 comprises a description of an aspect of the present invention that was submitted by the assignee of this patent application on Apr. 5, 2012 to the Federal Election Commission in advisory opinion request 2012-17.

While the present invention has been described in connection with preferred aspects, it will be understood by those skilled in the art that variations and modifications of the preferred aspects described above may be made without departing from the scope of the invention. Other aspects will be apparent to those skilled in the art from a consideration of the specification or from a practice of the invention disclosed herein. It is intended that the specification and the described examples are considered exemplary only, with the true scope of the invention indicated by the following claims.

What is claimed is:

1. A method for obtaining an attestation by a user via a mobile device, the method comprising:
receiving a request from the user;
sending a confirmation request message to a mobile number associated with the user, the confirmation request message including one or more statements to which a user's attestation is desired;
receiving a response message from the user, the response message being received based on the confirmation request message;
matching the response message with an expected response for certification by the user; and
accepting the request of the user on successful matching of the response message with the expected response.

2. The method as recited in claim 1, wherein the request is received through one of a Short Messaging Service (SMS) message, a data message, a website, a web page, an email, a Multimedia Messaging Service (MMS) message, Unstructured Supplementary Service Data (USSD) service, a voice call and a multimedia call.

3. The method as recited in claim 1, wherein the confirmation request message is sent by one or more of SMS service, USSD service, a push notification, an instant messaging service based on mobile number and means of directing a statement for attestation to a mobile device.

4. The method as recited in claim 1, wherein the response message is received via one or more of a short code for SMS reception, a long number for SMS reception, a USSD command, a website, a web page, an email, a MMS service, an instant messaging account on an instant messaging service based on mobile number and a voice call on a pre-defined number.

5. The method as recited in claim 1, wherein the confirmation request message includes one of a PIN, a verification code, a CAPTCHA, a unique image, a puzzle and a keyword.

6. The method as recited in claim 1, wherein the one or more statements comprises one or more of age of the user, gender of the user, other eligibility criteria of the user, citizenship or residence of the user, confirmation of order, confirmation of payment instruction, confirmation of subscription, confirmation of donation request, employment status of the user, organizational affiliation of the user, beliefs of the user, religion of the user and terms and conditions acceptance of an agreement.

7. The method as recited in claim 1, wherein accepting the request of the user comprises accepting the request on behalf of a third party.

8. The method as recited in claim 7, wherein the third party is one of a website, a subscription service, a membership or advocacy organization, a professional or trade association, a charity or non-profit organization, a newspaper or media publication, a video game provider, a political committee, and a government body.

9. The method as recited in claim 7 further comprising charging funds from an associated account of the user with a biller, the funds being charged on behalf of the third party.

10. The method as recited in claim 9, wherein the associated account is one of a credit card account, a public mobile operator account, an Internet service provider bill, a cable television, an interactive television bill, a broadband provider account, a utility bill, a phone bill, a debit card account, a checking account, a payroll account and a netbanking account.

11. The method as recited in claim 9 further comprising transmitting the charged funds to the third party.

12. The method as recited in claim 11, wherein transmitting the charged funds comprises transmitting the funds in advance, before receiving the charged funds from the biller.

13. The method as recited in claim 12 further comprising charging a financing fee for transmitting the funds in advance.

14. The method as recited in claim 12, wherein the transmitting the charged funds in advance comprises transmitting the funds partially.

15. The method as recited in claim 14 further comprising transmitting remaining portion of the charged funds after receiving the charged funds from the biller.

16. The method as recited in claim 9 further comprising tracking total funds received from the mobile number associated with the user.

17. The method as recited in claim 16 further comprising rejecting the request of the user for charging the associated account when the total funds received from the mobile number associated with the user exceed a pre-set amount.

18. The method as recited in claim 7 further comprising sending details of the acceptance of the request to the third party.

19. The method as recited in claim 1 further comprising sending a receipt of acceptance of the request to the user.

20. The method as recited in claim 1 further comprising verifying information provided by the user with the carrier subscriber account details associated with the mobile number of the user.

21. The method as recited in claim 1, wherein the mobile device is one of a mobile phone, a tablet PC, a netbook, an e-book reader, an embedded computing device and a PDA.

22. A system for obtaining an attestation by a user via a mobile device, the method comprising:
a request module, the request module receiving a request from the user;
a confirmation module for sending a confirmation request message to a mobile number associated with the user, the confirmation request message including one or more statements to which a user's attestation is desired;
a reception module, the reception module receiving a response message from the user, the response message being received based on the confirmation request message;
a match module, the match module matching the response message with an expected response for certification by the user; and
an accept module, the accept module accepting the request of the user on successful matching of the response message with the expected response.

23. The system as recited in claim 22, wherein the request is received through one of a Short Messaging Service (SMS) message, a data message, a website, a web page, an email, a Multimedia Messaging Service (MMS) message, Unstructured Supplementary Service Data (USSD) service, a voice call and a multimedia call.

24. The system as recited in claim 22, wherein the confirmation request message is sent by one or more of SMS service, USSD service, a push notification, an instant messaging service based on mobile number and means of directing a message to a mobile device.

25. The system as recited in claim 22, wherein the response message is received via one or more of a short code for SMS reception, a long number for SMS reception, a USSD command, a website, a web page, an email, a MMS service, an instant messaging account on an instant messaging service based on mobile number and a voice call on a pre-defined number.

26. The system as recited in claim 22, wherein the confirmation request message includes one of a PIN, a verification code, a CAPTCHA, a unique image, a puzzle and a keyword.

27. The system as recited in claim 22, wherein the one or more statements comprises one or more of age of the user, gender of the user, other eligibility criteria of the user, citizenship or residence of the user, confirmation of order, confirmation of payment instruction, confirmation of subscription, confirmation of donation request, employment status of the user, organizational affiliation of the user, beliefs of the user, religion of the user and terms and conditions acceptance of an agreement.

28. The system as recited in claim 22, wherein the accept module accepts the request on behalf of a third party.

29. The system as recited in claim 28, wherein the third party is one of a website, a subscription service, a membership or advocacy organization, a professional or trade association, a charity or non-profit organization, a newspaper or media publication, a video game provider, a political committee, and a government body.

30. The system as recited in claim 28 further comprising a payment module, the payment module charging funds from an associated account of the user with a biller, the funds being charged on behalf of the third party.

31. The method as recited in claim 30, wherein the associated account is one of a credit card account, a public mobile operator account, an internet service provider bill, a cable television, an interactive television bill, a broadband provider account, a utility bill, a phone bill, a debit card account, a checking account, a payroll account and a netbanking account.

32. The system as recited in claim 30 further comprising a remit module, the remit module transmitting the charged funds to the third party.

33. The system as recited in claim 32, wherein the remit module comprises an advance module, the advance module transmitting the charged funds in advance, before receiving the charged funds from the biller.

34. The system as recited in claim 33, wherein the advance module comprises a fee module, the fee module charging a financing fee for transmitting the funds in advance.

35. The system as recited in claim 33, wherein the advance module comprises a partial payment module, the partial payment module transmitting the charged funds in advance partially.

36. The system as recited in claim 35, wherein the advance module comprises a remaining payment module, the remaining payment module transmitting remaining portion of the charged funds after receiving the charged funds from the biller.

37. The system as recited in claim 30, wherein the payment module comprises a tracker module, the tracker module tracking total funds received from the mobile number associated with the user.

38. The system as recited in claim 37, wherein the payment module comprises a reject module for rejecting the request of the user for charging the associated account when the total funds received from the mobile number associated with the user exceed a pre-set amount.

39. The system as recited in claim 28 further comprising a forward module, the forward module sending a status of the request to the third party

40. The system as recited in claim 22 further comprising a receipt module, the receipt module sending a receipt of acceptance of the request to the user.

41. The system as recited in claim 22 further comprising a verification module, the verification module verifying information provided by the user with the carrier subscriber account details associated with the mobile number of the user.

42. The system as recited in claim 22, wherein the mobile device is one of a mobile phone, a tablet PC, a netbook, an e-book reader, an embedded computing device and a PDA.
